(19) United States
(12) Patent Application Publication
(10) Pub. No.: US 2014/0069411 A1
(43) Pub. Date: Mar. 13, 2014

(54) BARBECUE GRILL CABINET

(71) Applicant: Mo-Chung HUANG, Taitung County (TW)

(72) Inventor: Mo-Chung HUANG, Taitung County (TW)

(21) Appl. No.: 13/608,358

(22) Filed: Sep. 10, 2012

(51) Int. Cl. A47J 37/07

(52) U.S. Cl. 126/25 R

(57) ABSTRACT

A barbecue grill cabinet includes an opening at the top to hold a grid, a grease dripping space formed vertically in the interior from the opening, an air inlet located at the lower side to communicate with the interior of the barbecue grill cabinet and the opening, at least one holding portion located on one side wall and in the interior of the barbecue grill cabinet outside the grease dripping space to hold a heating source. The barbecue grill cabinet further has at least one heat collecting wall located between and inclined from the holding portion towards the opening to conduct heat of the heating source to heat foodstuffs held on the opening. Thus grease of the foodstuffs does not directly drip to the heating source to generate smoke.

### FIELD OF THE INVENTION

The present invention relates to a barbecue grill and particularly to a smokeless barbecue grill.

### BACKGROUND OF THE INVENTION

Modern people gradually have greater awareness and requirement for leisure activities. Barbecue is one of popular outdoor or social activities of many people, especially in some holiday seasons or occasions. Most conventional barbecue grills sold in the markets or malls include a hearth, a support rack and a grid. The hearth is mounted onto the support rack to hold charcoals. The grid is positioned above the hearth to hold foodstuffs to be grilled by the burning charcoals. For instance, R.O.C. patent No. M353712 entitled “Simplified barbecue grill equipped with a retractable grill pan” includes a grid bracket and a dual-purpose support rack connecting to the grid bracket. The support rack a U-shaped bar with two side bars to hold the grid bracket on the upper end in a movable manner, and upper end sections bent to form two horizontal holding sections. The two holding sections are bridged by a transverse bracing bar to hold a fire pan to hold charcoals. The fire pan is supported by the holding sections and bracing bar during movement with a greater contact surface between the fire pan and support rack so that the fire pan gets support from the bracing bar through out the movement without dropping. R.O.C. patent No. M398396 also provides a “Barbecue grill equipped with a flipping grid”. It includes a barbecue grill and an operation bar. The barbecue grill is pivotally coupled with a grid. The grid has at least one side provided with a first latch portion formed thereon. The operation bar has one end formed a second latch portion latchable with the first latch portion. Users can rotate the operation bar to flip the grid. It's simpler in structure and operation.

All the aforesaid conventional barbecue grills have the grid located above the burning charcoals. When users spread sauce, excessive sauce generally drips to the burning charcoals, or fat generated from the grilling meat also drips to the burning charcoals. As a result, smoke or harmful gas is generated and sucked by the user. Moreover, the grease dripping on the charcoals even increases the intensity of the burning flame that easily burns the foodstuffs held on the grid and generates carcinogenic substances. There are still rooms for improvement.

### SUMMARY OF THE INVENTION

The primary object of the present invention is to solve the problems of conventional barbecue grills that the fat from the foodstuffs or sauce spread onto the foodstuffs tends to drip to the heating source and generate harmful smoke or even burn the heating source, so that the foodstuffs is easily burnt to generate carcinogenic substances.

To achieve the foregoing object, the present invention provides a barbecue grill cabinet which includes an opening at the top of the barbecue grill cabinet to hold a grid, a grease dripping space formed vertically in the interior of the barbecue grill cabinet from the opening, an air inlet located at the lower side between side walls of the barbecue grill cabinet to communicate with the interior of the barbecue grill cabinet and the opening, at least one holding portion located on one side wall and in the interior of the barbecue grill cabinet outside the grease dripping space to hold a heating source, and at least one heat collecting wall located between the opening and the holding portion and inclined from the holding portion towards the opening. The holding portion has a loading port to load the heating source, a cover panel to cover the loading port, and a cover panel retainer fastened to the side wall to allow the cover panel to be opened or closed against the loading port.

In one aspect the cover panel retainer includes a fastening portion fastened to the barbecue grill cabinet and a pintle to allow the cover panel to be hinged on the fastening portion.

In another aspect the cover panel retainer includes a first slide track and a second slide track that oppose each other in a symmetrical manner to hold the cover panel between them.

In yet another aspect the heating source is selected from the group consisting of charcoals, electric heating tubes or a gas burner.

In yet another aspect the barbecue grill cabinet includes a base with a plurality of apertures formed thereon opposing to the opening.

The invention thus constructed provides many advantages, notably:

The heat collecting wall can collect and conduct heat generated by the heating source upward to the opening to heat the foodstuffs. Grease generated from the foodstuffs or sauce spread onto the foodstuffs does not directly drip to the heating source below the heat collecting wall to generate smoke. The loading port formed on the side wall at one side of the heating source can facilitate fast replacement of the heating source, and air can enter through the air inlet to enrich air content in the barbecue grill to facilitate burning of the heating source.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a first embodiment of the barbecue grill cabinet of the invention.

FIG. 2 is a schematic view of the first embodiment of the barbecue grill cabinet of the invention in an assembly condition.

FIG. 3 is a sectional view of the first embodiment of the barbecue grill cabinet of the invention.

FIG. 4 is a schematic view of the first embodiment of the invention in a use condition.

FIG. 5 is a perspective view of a second embodiment of the barbecue grill cabinet of the invention.

FIG. 6 is a sectional view of a third embodiment of the barbecue grill cabinet of the invention.

FIG. 7 is a sectional view of a fourth embodiment of the barbecue grill cabinet of the invention.

### DETAILED DESCRIPTION OF THE PREFERRED EMBODIMENTS

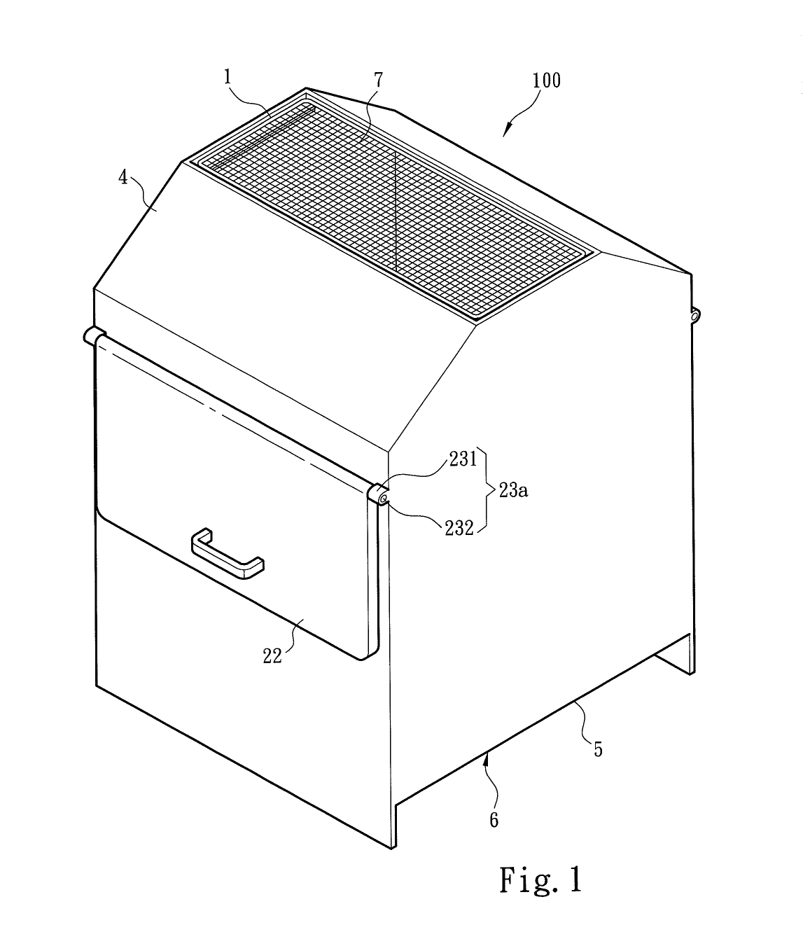

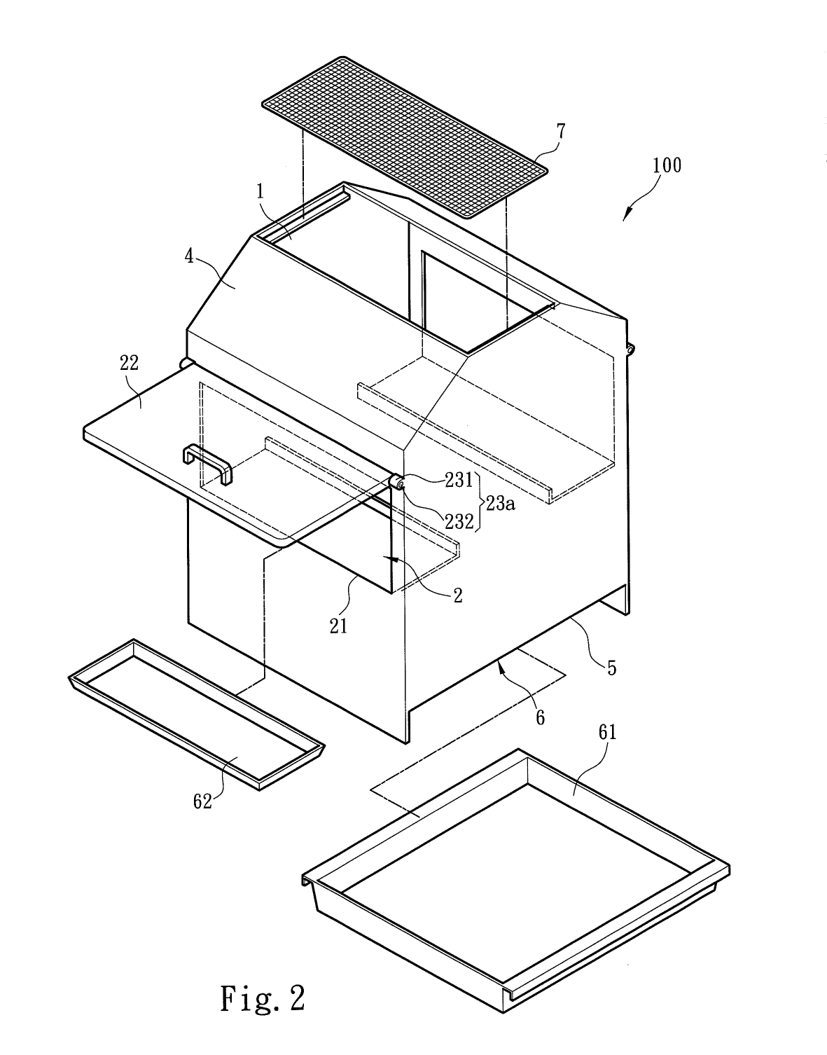

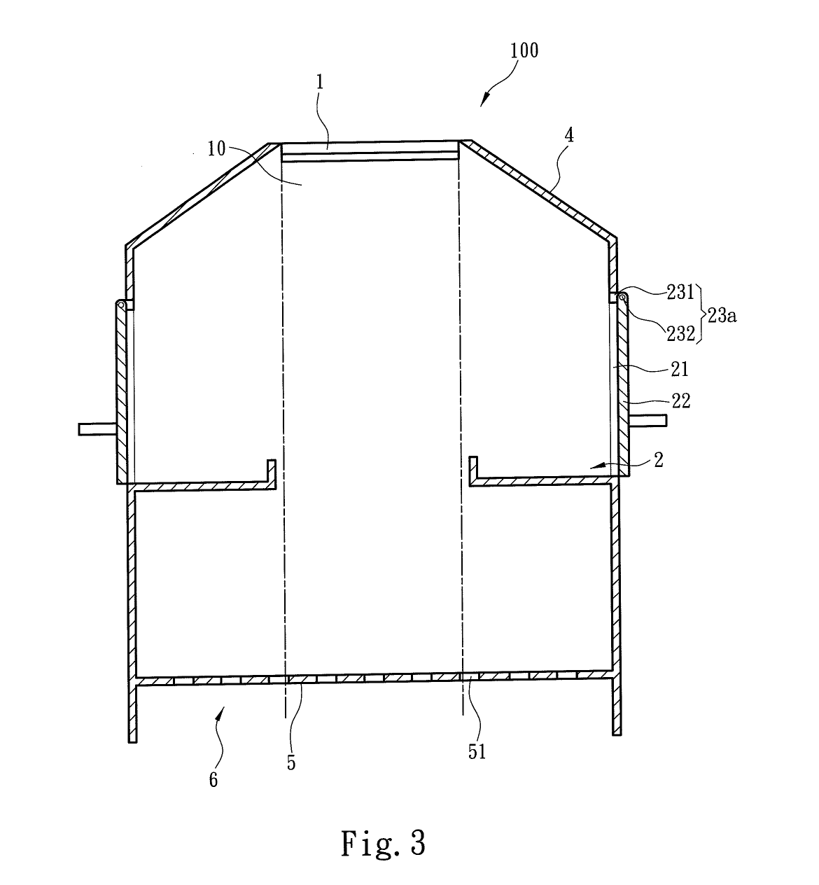

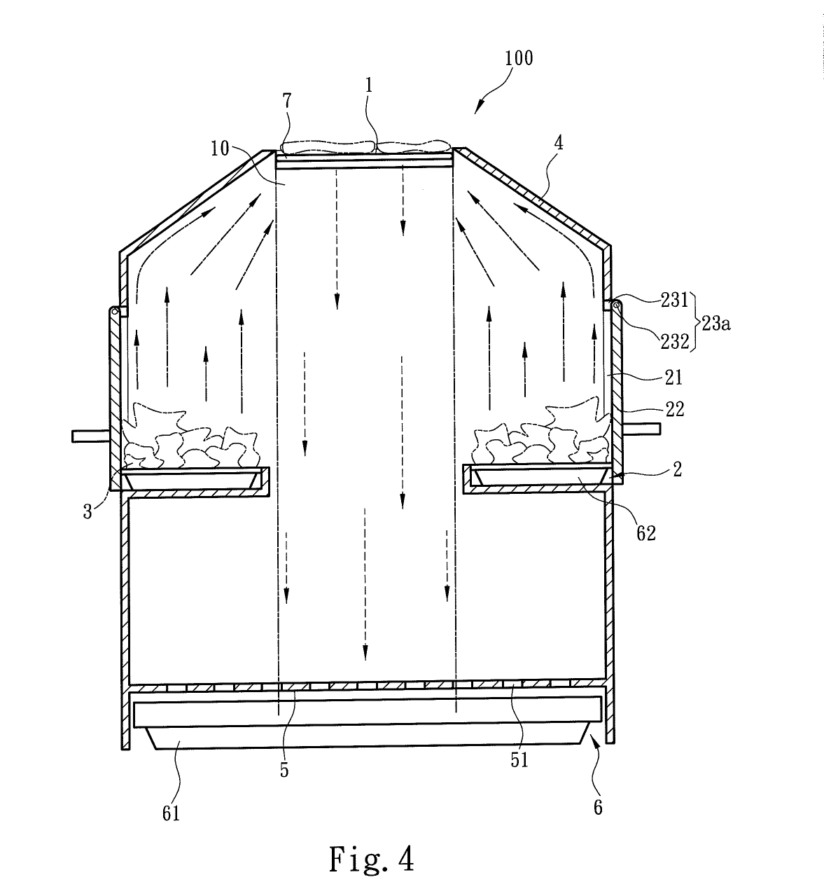

Please refer to FIGS. 1 and 2 for a first embodiment of the invention. The invention provides a barbecue grill cabinet 100 which includes an opening 1 at the top to hold a grid 7, a grease dripping space 10 (referring to FIG. 3) formed vertically in the interior of the barbecue grill cabinet 100 from the opening 1, an air inlet 6 located at the lower side between side walls of the barbecue grill cabinet 100 to communicate with the interior of the barbecue grill cabinet 100 and the opening 1, at least one holding portion 2 located on one side wall and in the interior of the barbecue grill cabinet 100 outside the grease dripping space 10 to hold a heating source 3 (referring to FIG. 4), and at least one heat collecting wall 4 located between the opening 1 and holding portion 2. The holding portion 2 has a loading port 21 to load the heating source 3, a cover panel 22 to cover the loading port 21, and a cover panel retainer 23a fastened to the side wall to allow the cover panel 22 to be opened or closed against the loading port 21. The heat collecting wall 4 is inclined from the holding portion 2 towards the opening 1 to conduct heat generated by the heating source 3 towards the opening 1.

Please refer to FIGS. 2 and 3, in the first embodiment, the cover panel retainer 23a is located on the side wall of the barbecue grill cabinet 100 and includes a fastening portion 231 fastened to the barbecue grill cabinet 100 and a pintle 232 to allow the cover panel 22 to be hinged on the fastening portion 231 so that the cover panel 22 can be swung about the pintle 232 to be opened or closed against the loading port 21 and the user can load a holding pan 62 with the heating source 3 (referring to FIG. 4) into the holding portion 2. The barbecue grill cabinet 100 also has a base 5 relative to the opening 1 with a plurality of apertures 51 formed thereon to communicate with the opening 1 and air inlet 6. Air can pass through the air inlet 6 and apertures 51 to enter the barbecue grill cabinet 100. A grease collection tray 61 is provided and loaded through the air inlet 6 beneath the base 5 opposing to the opening 1 to collect grease generated by fat-contained foodstuffs or dripping of excessive sauce spread onto the foodstuffs.

Please refer to FIG. 4 for the first embodiment of the barbecue grill cabinet 100 in a use condition. Through the cover panel retainer 23a the cover panel 22 can be opened easily; then load the holding pan 62 contained the heating source 3 through the loading port 21 and close the cover panel 22. The heating source 3 can be charcoals, electric heating tubes or a gas burner. The heating source 3 is located below the heat collecting wall 4. Heat generated by the heating source 3 is collected and conducted by the heat collecting wall 4 to the opening 1 to heat the foodstuffs held on the grid 7. Grease of the fat-contained foodstuffs directly drips downwards and passes through the grease dripping space 10 onto the grease collection tray 61 loaded through the air inlet 6 without accumulating in the barbecue grill cabinet 100. The waste grease can be disposed after finish of barbecue to facilitate cleaning without dripping to the heating source 3 to generate harmful smoke, and no carcinogenic substances are generated from the charred foodstuffs caused by burning heating source 3. The air can enter through the air inlet 6 into the barbecue grill cabinet 100 to facilitate burning of the heating source 3.

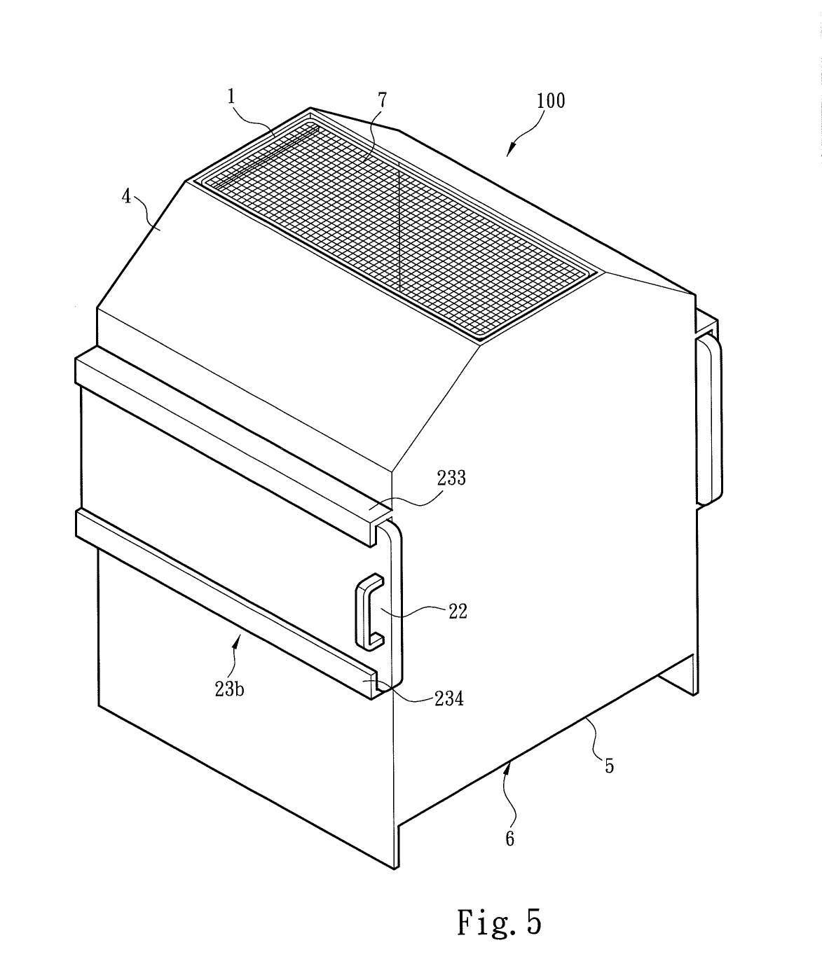

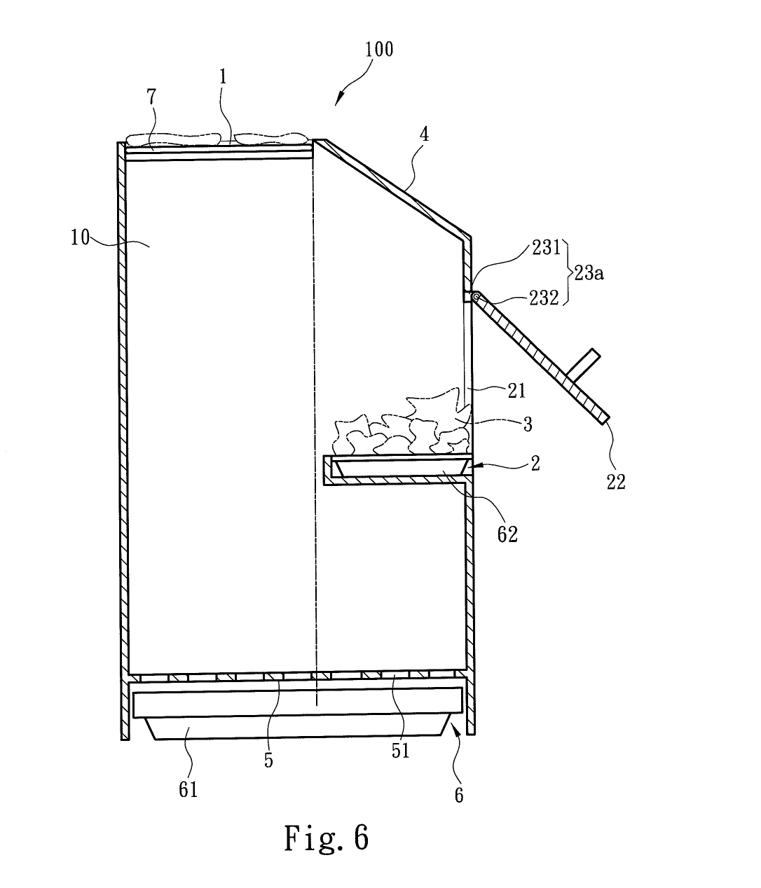

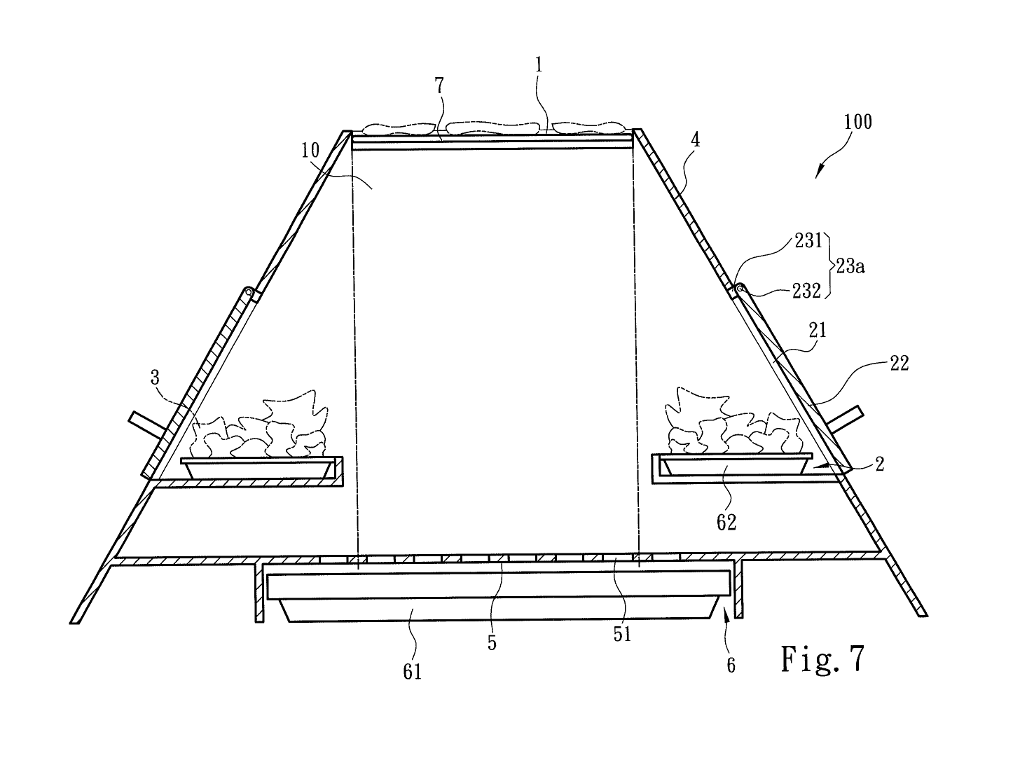

Please refer to FIGS. 5, 6 and 7 for second, third and fourth embodiments of the invention. In the second embodiment, the cover panel retainer 23b is located on the side wall of the barbecue grill cabinet 100, and includes a first slide track 233 and a second slide track 234 that oppose each other in a symmetrical manner to hold the cover panel 22 between them. The cover panel 22 covers the loading port 21 and can slide along the first and second slide tracks 233 and 234 transversely to open and close the loading port 21 (referring to FIG. 5). Moreover, the loading port 21 is to facilitate loading of the holding pan 62 with the heating source 3 into the holding portion 2. Thus the heat generated by the heating source 3 can be conducted to heat the foodstuffs held on the opening 1 through the heat collecting wall 4. Grease generated from the fat-contained foodstuffs or excessive sauce spread onto the foodstuffs is directly dripped from the grid 7 to the grease collection tray 61 without dripping to the heating source 3, thus no smoke is generated. The barbecue grill cabinet 100 can also be made with a single grilling zone and a single heating side as shown in FIG. 6. The size of the barbecue grill cabinet 100 thus formed can be shrunk one half of the first embodiment to be used by fewer users. Its overall structure is substantially same as previously discussed and differs only in the single side heating design, thus details are omitted. The heat collecting wall 4 and cover panel 22 also can be located at the same plane to make the barbecue grill cabinet 100 be formed in a trapezoidal shape (referring to FIG. 7). Its overall structure also is substantially same previously discussed, and differs only in the design of the trapezoidal profile of the cabinet, hence details also are omitted herein.

In short, the invention provides the heat collecting wall 4 to collect and conduct heat generated by the heating source 3 towards the opening 1 to heat the foodstuffs. Grease generated from the foodstuffs or excessive sauce spread onto the foodstuffs does not directly drip to the heating source 3 below the heat collecting wall 4 to generate smoke or cause burning of the heating source 3 that might otherwise burn the foodstuffs to generate carcinogenic substances. Moreover, the loading port 21 on the side wall of the barbecue grill cabinet 100 at one side of the heating source 3 allows users to replace the heating source 3 quickly and easily. Air can enter through the air inlet 6 to enrich air content in the barbecue grill cabinet 100 to facilitate burning of the heating source 3. As a result, a smokeless, safer and more sanitary barbecue environment can be created without generating charred carcinogenic foodstuffs, and users can eat and enjoy the grilled foodstuffs safely and heartily.

While the preferred embodiments of the invention have been set forth for the purpose of disclosure, they are not the limitations of the invention, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A barbecue grill cabinet, comprising:
an opening which is located at a top of the barbecue grill cabinet to hold a grid and forms a grease dripping space vertically with an interior of the barbecue grill cabinet;
an air inlet located at a lower side between side walls of the barbecue grill cabinet to communicate with the opening and the interior thereof;
at least one holding portion which is located on each of the side walls and in the interior of the barbecue grill cabinet outside the grease dripping space to hold a heating source and includes a loading port to load the heating source, a cover panel to cover the loading port and a cover panel retainer fastened to one of the side walls to allow the cover panel to be opened and closed against the loading port; and
at least one heat collecting wall located between the opening and the at least one holding portion and inclined from the at least one holding portion towards the opening.

2. The barbecue grill cabinet of claim 1, wherein the cover panel retainer includes a fastening portion fastened to the barbecue grill cabinet and a pintle to allow the cover panel to be hinged on the fastening portion.

3. The barbecue grill cabinet of claim 1, wherein the cover panel retainer includes a first slide track and a second slide track that oppose each other in a symmetrical manner, the cover panel being held between the first and second slide tracks.

4. The barbecue grill cabinet of claim 1, wherein the heating source is selected from the group consisting of charcoals, electric heating tubes and a gas burner.

5. The barbecue grill cabinet of claim 1 further comprising a base which includes a plurality of apertures opposing to the opening.
